(19) United States
(12) Patent Application Publication
(10) Pub. No.: US 2022/0105952 A1
(43) Pub. Date: Apr. 7, 2022

(54) METHOD FOR ACTIVATING SAFETY FEATURES UPON DETECTION OF DRIVER IMPAIRMENT

(71) Applicant: Continental Automotive Systems, Inc., Auburn Hills, MI (US)

(72) Inventors: Sina Gholamnejad Davani, Troy, MI (US); Peter Lamprecht, Shelby Township, MI (US); Joseph Brian Burtch, Lake Orion, MI (US); Nizar Ahamed, Farmington Hills, MI (US)

(73) Assignee: Continental Automotive Systems, Inc., Auburn Hills, MI (US)

(21) Appl. No.: 17/060,838

(22) Filed: Oct. 1, 2020

(51) Int. Cl. B60W 50/16; B60W 40/09; G06K 9/00

(52) U.S. Cl. CPC B60W 50/16; B60W 2050/143; G06K 9/00845; B60W 40/09

(57) ABSTRACT

A system that can detect a driver's condition and as a result, activates one or more of the manually disabled safety features and substantially reduces chances of an accident. Additional actions to alert the driver can occur including, but not limited to, vibration of seats, pedals, and steering wheel, pumping the brakes, blasting the radio could occur. A method includes detecting driver condition of a driver, enabling one or more vehicle safety features of a vehicle and overriding disabled one or more vehicle safety features if: driver impairment is detected while detecting driver condition, and vehicle safety features have been disabled by the driver or a passenger.

### TECHNICAL FIELD

The disclosure herein relates to a method for activating safety features upon detection of driver impairment.

### TECHNICAL BACKGROUND

Drivers are often unaware of the effects that drowsiness and distraction have on their own abilities for vehicle control. Humans in general, and particularly as drivers, are poor judges of their own performance capabilities. Even drivers who have good driving skills, will not perform uniformly at all times when behind the wheel of a vehicle. In addition, there are many times during driving trips that very little demand is placed on the driver with respect to execution of driving tasks. As a result, drivers are lulled into states of mind where little attention is being devoted to the driving task which can lead to increase in vehicular collisions. In addition, fatigue impairs driver performance, alertness and judgment. Collisions caused by drowsiness are a serious road safety problem, and fatigue has been estimated to be involved in as many as twenty-three percent of all crashes.

Drivers cannot reliably determine when they are impaired by fatigue to the point of having a serious vigilance lapse or uncontrolled sleep attacks. The attention management systems outlined herein are intended to increase safety by assisting the driver in drowsy, distractive, and/or high workload situations.

To assist drivers, for instance when they are drowsy or distracted, automakers are including more and more advanced safety systems, such as automatic emergency braking, lane keep assist, advanced cameras, and rear-seat reminder systems. Those features are making cars safer while vehicles are being driven. However, some drivers do not like all of the features as they can limit the control the driver has over the vehicle and automakers have provided the ability to disable these features. After the features have been disabled for a while, the driver may forget the features have been disabled, and the driver may experience drowsiness and/or distraction without the benefit of the safety features.

### BRIEF SUMMARY

A system that can detect a driver's condition and as a result, activates one or more of the manually disabled safety features and substantially reduces chances of an accident. Additional actions to alert the driver can occur including, but not limited to, vibration of seats, pedals, and steering wheel, pumping the brakes, blasting the radio could occur.

A method includes detecting driver condition of a driver, enabling one or more vehicle safety features of a vehicle and overriding disabled one or more vehicle safety features if: driver impairment is detected while detecting driver condition, and vehicle safety features have been disabled by the driver or a passenger.

In one or more embodiments, the vehicle safety features include automatic emergency braking, lane keep assist, or advanced cameras.

In one or more embodiments, detecting driver condition includes detecting with a driver facing camera.

In one or more embodiments, the driver facing camera is a dashboard camera.

In one or more embodiments, detecting driver condition includes using computer vision.

In one or more embodiments, detecting driver condition occurs while the driver is driving the vehicle.

In one or more embodiments, detecting driver condition includes sensing driver condition with sensors and interpreting motion data.

In one or more embodiments, the method further includes alerting the driver.

In one or more embodiments, alerting the driver includes vibrating seats.

In one or more embodiments, alerting the driver includes vibrating the brake or acceleration pedals.

In one or more embodiments, alerting the driver includes vibrating the steering wheel.

In one or more embodiments, alerting the driver includes pumping brakes of the vehicle.

In one or more embodiments, alerting the driver includes playing the radio.

### BRIEF DESCRIPTION OF THE DRAWINGS

FIG. 1 illustrates a system with disabled vehicle safety features as constructed in accordance with one or more embodiments.

FIG. 2 illustrates detection of an impaired driver.

FIG. 3 illustrates a system with automatic enabling of vehicle safety features and risk mitigation, as constructed in accordance with one or more embodiments.

FIG. 4 illustrates a flowchart illustrating a method of use of the system, as constructed in accordance with one or more embodiments.

These and other embodiments, aspects, advantages, and features of the present invention will be set forth in part in the description which follows and will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

A system that can detect a driver's condition and as a result, activates one or more of the manually disabled safety features and substantially reduces chances of an accident. Additional actions to alert the driver can occur including, but not limited to, vibration of seats, pedals, and steering wheel, pumping the brakes, blasting the radio could occur.

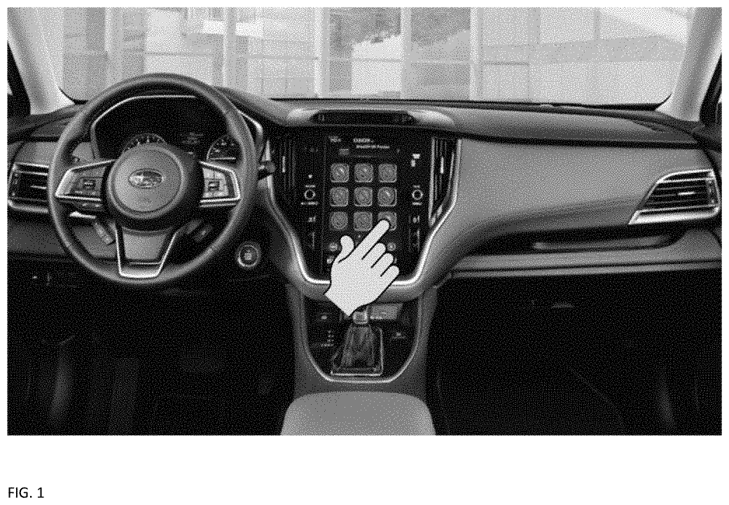

FIG. 1 illustrates an example vehicle which includes one or more safety features, such as, but not limited to, airbags, antilock brakes, traction control, electronic stability control, accident avoidance systems, tire pressure monitors, lane keep assist, or emergency braking. As shown in FIG. 1, the driver or passenger can disable one or more of the safety features.

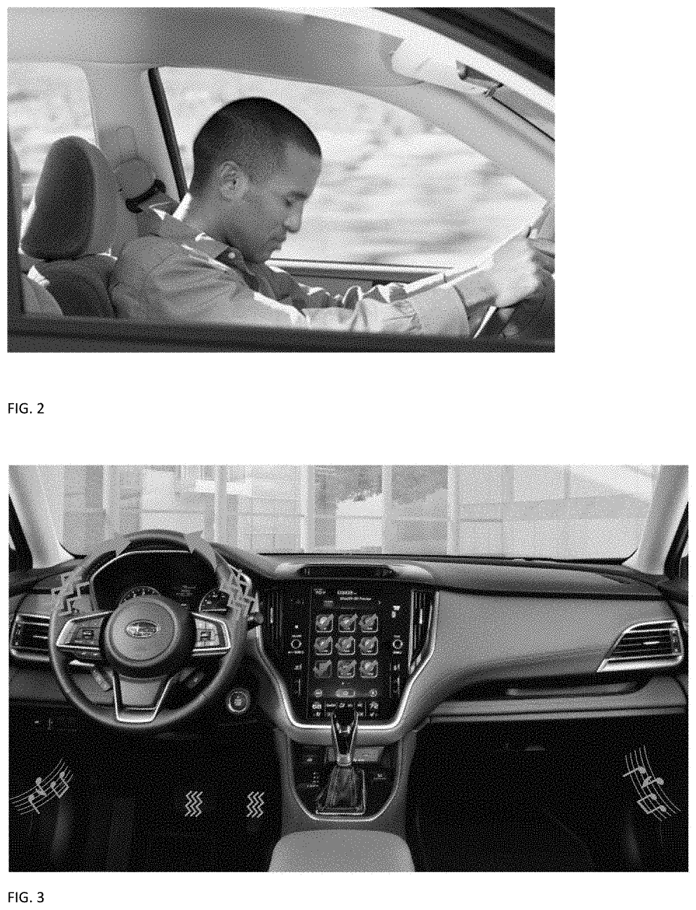

The system includes a detection device to detect the condition of a driver. In one or more embodiments, the detection device includes camera and/or driver-facing dashboard camera. In a further embodiment, the detection device includes computer vision. Computer vision techniques include, but are not limited to, eye tracking, face recognition and tracking, blink rate detection, and eye openness detection. The detection device detects whether the driver is impaired, for example drowsy, dizzy, or falling asleep, for example as shown in FIG. 2. Upon detection of impairment of the driver, the system can re-enable the safety features for the driver.

As shown in FIG. 3, the system includes features which can alert the driver when the system detects the driver is impaired. For instance, a vibration system is disposed within the driver seat and is connected to a controller. When it has been detected the driver is impaired, the driver can be alerted via the vibration system in the seat by vibrating the seat. In one or more embodiments, the system includes a vibration system connected to the brake pedal and/or the acceleration pedal, and also a controller. When the system has detected the driver is impaired, the driver can be alerted via the vibration system connected to the pedals. In one or more embodiments, a vibration system is disposed within the steering wheel and is connected to a controller. When it has been detected the driver is impaired, the driver can be alerted via the vibration system in the steering by vibrating the steering.

In one or more embodiments, the system includes a brake system connected to a controller. When the system has detected the driver is impaired, the driver can be alerted by the brake system pumping the brakes and ultimately jostling the driver.

In one or more embodiments, the system is coupled with the audio system of the vehicle via a controller. When the system has detected the driver is impaired, the driver can be alerted by the audio system when the radio is played at a higher than normal volume, or a pre-recorded message could be played for the driver to warn the driver.

In one or more embodiments, one or more features which alert the driver are implemented upon detection of driver impairment. In one or more embodiments, all of the features which alert the driver are implemented simultaneously upon detection of driver impairment to alert the driver.

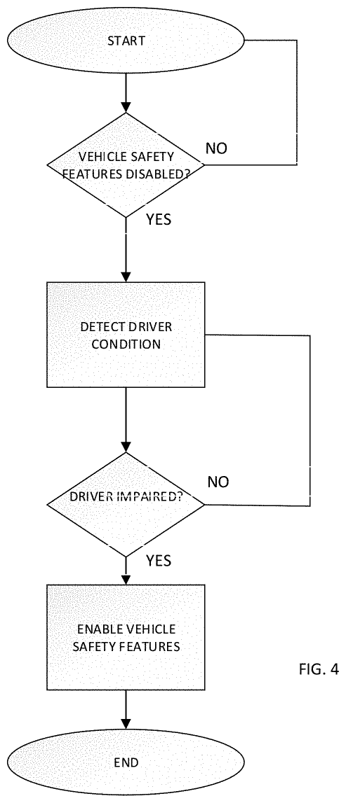

As shown in FIG. 4, a method includes detecting driver condition of a driver, enabling one or more vehicle safety features of a vehicle and overriding disabled one or more vehicle safety features if: driver impairment is detected while detecting driver condition, and vehicle safety features have been disabled by the driver or a passenger.

In one or more embodiments, the vehicle safety features include automatic emergency braking, lane keep assist, or advanced cameras.

In one or more embodiments, detecting driver condition includes detecting with a driver facing camera.

In one or more embodiments, the driver facing camera is a dashboard camera.

In one or more embodiments, detecting driver condition includes using computer vision.

In one or more embodiments, detecting driver condition occurs while the driver is driving the vehicle.

In one or more embodiments, detecting driver condition includes sensing driver condition with sensors and interpreting motion data.

In one or more embodiments, the method further includes alerting the driver.

In one or more embodiments, alerting the driver includes vibrating seats.

In one or more embodiments, alerting the driver includes vibrating the brake or acceleration pedals.

In one or more embodiments, alerting the driver includes vibrating the steering wheel.

In one or more embodiments, alerting the driver includes pumping brakes of the vehicle.

In one or more embodiments, alerting the driver includes playing the radio.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

The mentioned steps of the method may be executed in the sequence indicated. However, they may also be executed in a different order. In one of its embodiments, for example with a specific combination of steps, the method according to the invention may be carried out in such a way that no further steps are executed. However, in principle, further steps may also be executed, even steps of a kind which have not been mentioned.

The claims which form part of the application do not represent any dispensing with the attainment of further protection.

1. A method comprising:
detecting driver condition of a driver;
enabling one or more vehicle safety features of a vehicle and overriding disabled one or more vehicle safety features if:
driver impairment is detected while detecting driver condition; and
vehicle safety features have been disabled by the driver or a passenger.

2. The method as recited in claim 1, wherein the vehicle safety features include automatic emergency braking, lane keep assist, or advanced cameras.

3. The method as recited in claim 1, wherein detecting driver condition includes detecting with a driver facing camera.

4. The method as recited in claim 3, wherein the driver facing camera is a dashboard camera.

5. The method as recited in claim 1, wherein detecting driver condition includes using computer vision.

6. The method as recited in claim 1, wherein detecting driver condition occurs while the driver is driving the vehicle.

7. The method as recited in claim 1, wherein detecting driver condition includes sensing driver condition with sensors and interpreting motion data.

8. The method as recited in claim 1, further comprising alerting the driver.

9. The method as recited in claim 8, wherein alerting the driver includes vibrating seats.

10. The method as recited in claim 8, wherein alerting the driver includes vibrating the brake or acceleration pedals.

11. The method as recited in claim 8, wherein alerting the driver includes vibrating the steering wheel.

12. The method as recited in claim 8, wherein alerting the driver includes pumping brakes of the vehicle.

13. The method as recited in claim 8, wherein alerting the driver includes playing the radio.
